(19) United States
(12) Patent Application Publication
(10) Pub. No.: US 2026/0120420 A1
(43) Pub. Date: Apr. 30, 2026

(54) REALITYFENCE ADAPTION ENGINE

(71) Applicant: Andrew Baskin, West Bloomfield, MI (US)

(72) Inventor: Andrew Baskin, West Bloomfield, MI (US)

(21) Appl. No.: 19/076,044

(22) Filed: Mar. 11, 2025

Related U.S. Application Data
(60) Provisional application No. 63/714,349, filed on Oct. 31, 2024.

(51) Int. Cl. G06T 19/20

(52) U.S. Cl. CPC G06T 19/20; G06T 2219/2016

(57) ABSTRACT

A computer-implemented method for real-time three-dimensional model adaptation and visualization, the method may include rendering, via a computing device, a fence in a three-dimensional computer model; and dynamically scaling, via the computing device, the fence in real-time based on user input to the three-dimensional computer model.

### CROSS-REFERENCE TO RELATED APPLICATIONS

The present application claims priority to U.S. Provisional Application No. 63/714,349 filed Oct. 31, 2024, titled “REALITY FENCE ADAPTION ENGINE,” which is hereby incorporated by reference in its entirety.

### TECHNICAL FIELD

The embodiments generally relate to the technical field of real-time three-dimensional model adaptation and visualization.

### BACKGROUND

The adaptation and visualization of three-dimensional (3D) models play a crucial role in various industries, including construction, architecture, and consumer product customization. Traditional methods for designing and adjusting 3D models often require extensive manual input and technical expertise, limiting accessibility for general users and slowing down the customization process. When applied to fencing design, existing solutions often rely on static templates or pre-rendered images that do not offer real-time adaptability to different spatial constraints or user preferences. As a result, customers and businesses struggle to efficiently visualize and modify fence designs to meet specific requirements.

While some 3D modeling software solutions provide limited customization features, they generally require significant user intervention and do not dynamically adjust in real time based on user input. For instance, conventional modeling tools often necessitate manual scaling, positioning, and resizing of individual components, such as fence posts, panels, and gates. These tools may also lack intuitive user interactions, such as drag-and-drop or real-time scaling, which would otherwise simplify the customization process. Additionally, current solutions frequently require professional design software, which can be costly and difficult for non-experts to use.

Furthermore, existing fencing visualization methods do not seamlessly integrate real-time modifications based on user input, leading to inefficiencies in design iteration. Customers may need to rely on physical blueprints, static renderings, or external design consultations to finalize fence dimensions and layout. This disjointed approach results in increased time, cost, and effort in the design process. Without a system that allows for intuitive, real-time modifications within a 3D environment, users face significant challenges in accurately adapting fence models to fit their specific needs.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A system and method for real-time three-dimensional model adaptation and visualization enable users to dynamically modify a 3D fence model based on interactive input. The system allows users to render a fence within a virtual environment and scale its components in real time. Through an intuitive interface, users can modify the dimensions and layout of the fence, including adjusting the placement and size of fence panels, posts, and gates, without requiring extensive technical expertise.

The system provides an interactive drag-and-drop interface that facilitates the seamless insertion and adjustment of fence components. Users can add or remove posts, gates, and panels while the system dynamically updates the 3D model to reflect these changes. The adaptive rendering engine ensures that modifications maintain realistic proportions and structural integrity, allowing for accurate visual representation and efficient design iteration.

The disclosed system also includes support for real-time scaling, where users can modify the length of individual panels and posts between predefined dimensions, such as one to eight, ten, twelve, or fifteen feet, or other project-specific dimensions, ensuring precise customization. Additionally, the system incorporates various forms of user input, including drag-to-scale and drag-and-drop interactions, making the design process more intuitive and accessible.

In some embodiments, the system is implemented as a software platform operating on a computing device connected to a network. A server application hosts the 3D rendering engine, enabling users to access and manipulate fence models from different devices. The system ensures that changes made in real time are synchronized across connected devices, improving collaboration between customers, contractors, and designers.

By integrating real-time model adaptation, interactive input mechanisms, and scalable customization features, the disclosed system significantly enhances the efficiency and usability of fence design visualization. The system enables users to generate precise and realistic fence models tailored to their specific needs, eliminating the limitations of static templates and manual design adjustments.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments; and

FIGS. 3-5 illustrate example user interfaces of a real-time three-dimensional fence model adaptation and visualization tool, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The system for real-time three-dimensional model adaptation and visualization includes a computing device configured to execute software instructions that enable users to modify a three-dimensional (3D) fence model dynamically. The computing device may include a processor, memory, a display interface, and input devices such as a touchscreen, mouse, or stylus. The system may be implemented as a standalone application, a web-based platform, or a mobile application, and may communicate with a remote application server over a network to process user interactions and render updates in real time.

The system may initialize by rendering a fence in a three-dimensional computer model. The fence may be composed of multiple elements, including posts, gates, and panels, which are represented as distinct digital objects within the model. The system may display the 3D model within a graphical user interface (GUI) that allows users to interact with the model through input mechanisms such as clicking, dragging, and resizing components.

The system may receive user input to dynamically scale the fence in real time. The scaling operation may adjust dimensions, including length, width, and height, based on the user's input. The system may support drag-to-scale interactions, where a user selects a component and modifies its dimensions by dragging interface elements. Alternatively, drag-and-drop functionality may allow users to insert new components, such as posts, gates, or panels, into the model. The system may update the entire fence configuration in response to these modifications, recalculating spacing, alignment, and positioning to maintain structural consistency.

When a user inserts a new fence component, the system may modify adjacent components to accommodate the insertion. For example, if a post is added, the system may reposition surrounding panels and gates to ensure uniform spacing. If a gate is inserted, the system may adjust the dimensions of adjacent panels to accommodate the new element while maintaining proportional relationships between components.

The system may enforce predefined constraints to maintain realistic proportions and prevent design inconsistencies. Panels and posts may be scaled between predefined minimum and maximum lengths, such as between one to eight, ten, twelve, fifteen, or eighteen feet, or other project-specific dimensions, ensuring that user modifications result in practical configurations. Additional constraints may ensure that posts remain properly aligned and that gates maintain an appropriate width for functional use.

The system may be deployed in various environments, including web-based platforms and standalone applications. In web-based implementations, the system may communicate with an application server that processes user input and renders real-time updates. The server may transmit updated model data to the client device, ensuring synchronized visualization across multiple user sessions.

The system may incorporate predefined fence templates that users can modify. These templates may provide a starting point for customization, allowing users to select from different fence styles, materials, and configurations before making modifications. Users may further adjust individual components to tailor the design to specific requirements.

The system may generate real-time feedback and validation messages to guide user modifications. If a modification results in overlapping components, incorrect spacing, or unrealistic proportions, the system may generate alerts and suggest corrective actions. These validation mechanisms may prevent users from creating impractical designs and ensure structural feasibility.

The system may integrate with external software applications, such as architectural modeling software, construction planning tools, or e-commerce platforms. Integration may enable users to export finalized fence designs for further refinement, cost estimation, or direct ordering of materials.

The computing device executing the system may include a processor that executes software instructions, memory that stores data and application code, and a display interface that renders the 3D model. The device may include network connectivity features that allow it to communicate with remote servers to synchronize data and support collaborative design efforts.

The system may be implemented using software modules that perform distinct functions. A rendering engine may generate the visual representation of the fence model. A user interface module may manage GUI elements and receive input. An interaction handler may process user actions, such as scaling and inserting components. A real-time scaling module may ensure proportional resizing and maintain predefined constraints.

The system may enable users to rapidly iterate on fence designs, making adjustments and visualizing changes in real time. By supporting various input mechanisms, dynamic scaling, and integration with external tools, the system may facilitate the creation of accurate and customized fence models suited to specific user needs.

Various implementations of the invention involve the technical field of real-time three-dimensional model adaptation and visualization including rendering, via a computing device, a fence in a three-dimensional computer model; and dynamically scaling, via the computing device, the fence in real-time based on user input to the three-dimensional computer model and are therefore necessarily rooted in computer technology. For example, the aforementioned steps are inherently computer-based and cannot be performed in the human mind. Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

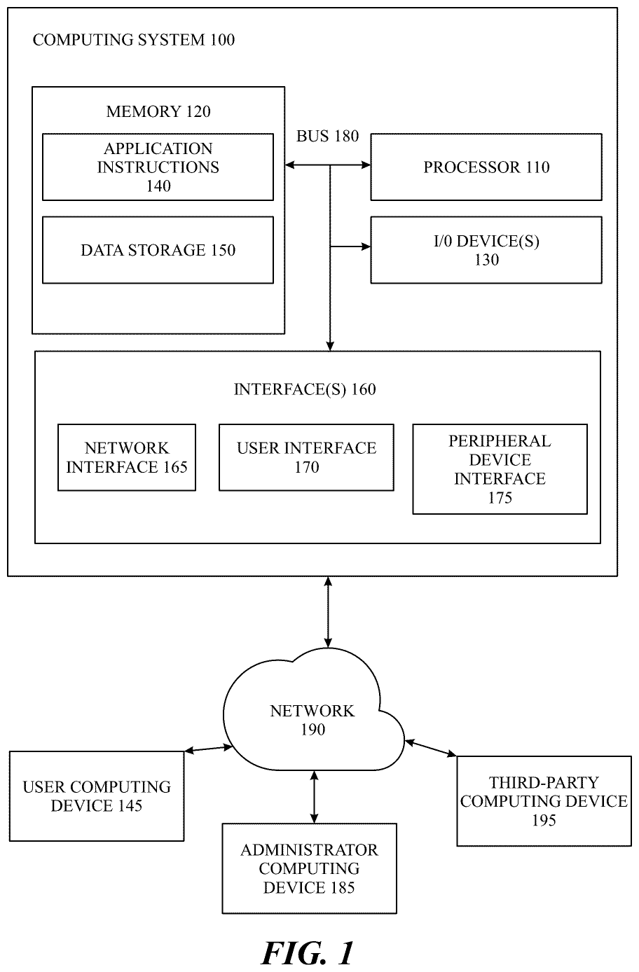

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

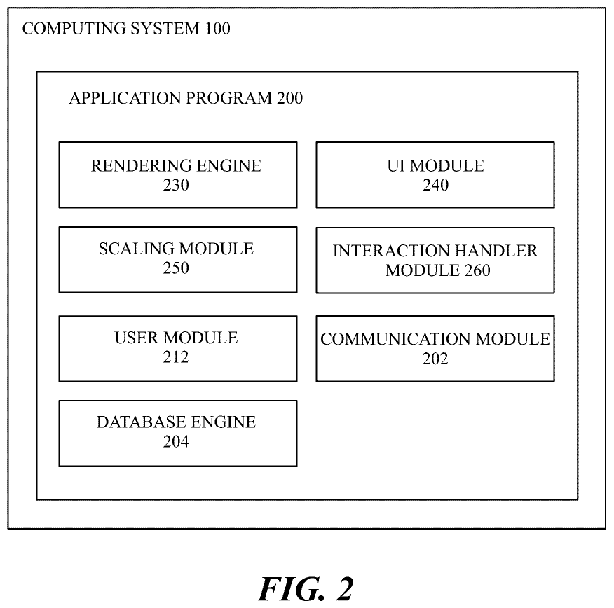

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a rendering engine 230, a user interface module 240, an interaction handler module 260, a real-time scaling module 250, a communication module 202, a database engine 204, a user module 212, and a display module 216.

In some embodiments, the rendering engine 230 module is configured to generate and display a three-dimensional (3D) representation of a fence model within a graphical user interface (GUI). The rendering engine may utilize hardware-accelerated graphics libraries such as OpenGL, DirectX, or WebGL to efficiently render complex 3D objects with realistic textures, shading, and lighting effects. The module may dynamically update the visual representation of the fence as modifications are made, ensuring real-time visualization of user adjustments. The rendering engine 230 may process geometric data representing individual fence components, such as posts, panels, and gates, translating these components into a structured 3D model. It may support multiple levels of detail, optimizing rendering performance based on system capabilities and user interaction. The engine may handle occlusion, depth perception, and camera controls, allowing users to zoom, rotate, and pan the view to inspect the fence model from different perspectives. Additionally, the rendering engine 230 may integrate with real-time scaling and interaction handling modules to reflect changes instantly. When a user modifies a fence component, such as resizing a panel or inserting a gate, the engine may recalculate and redraw the affected portions of the model. It may also apply visual constraints to ensure proportional adjustments, maintaining realistic representations of fence structures.

In some embodiments, the user interface module 240 is configured to manage and present graphical user interface (GUI) elements that facilitate user interaction with the three-dimensional (3D) fence modeling system. The module may generate and display UI components such as buttons, menus, sliders, and input fields that allow users to create, modify, and customize fence models in real time. The user interface module may provide an intuitive workspace where users can interact with the 3D model using various input mechanisms, including mouse clicks, touch gestures, keyboard shortcuts, and stylus inputs. The user interface module 240 may include interactive controls for selecting and manipulating fence components, such as posts, gates, and panels. Users may add new elements by selecting components from a menu and dragging them into the 3D workspace, where they can be positioned, resized, or rotated. The module may also provide controls for dynamically scaling fence components, allowing users to adjust the length of panels, the height of posts, and the width of gates using drag-to-scale functionality. To enhance usability, the user interface module may support visual feedback mechanisms, such as highlighting selected components, displaying tooltips with relevant information, and providing real-time validation messages. If a user attempts to create an invalid configuration, such as overlapping components or exceeding predefined size constraints, the module may generate alerts and suggest corrective actions. In some embodiments, the user interface module 240 may support multiple viewing modes, allowing users to switch between different perspectives, such as top-down, side, and isometric views. It may also integrate with the rendering engine 230 to enable real-time updates, ensuring that any modifications made through the interface are immediately reflected in the 3D model.

In some embodiments, the interaction handler module 260 is configured to process user inputs and translate them into real-time modifications of the 3D fence model. This module detects and interprets actions such as clicking, dragging, resizing, and inserting components, ensuring seamless interaction between users and the graphical interface. The interaction handler module 260 may manage drag-and-drop functionality, allowing users to place and reposition fence components, including posts, gates, and panels. It may also process drag-to-scale inputs, adjusting component dimensions dynamically while enforcing predefined constraints to maintain structural consistency. The module ensures that changes are reflected immediately by coordinating with the rendering engine 230. Additionally, it may implement validation rules to prevent overlapping components or unrealistic configurations, providing corrective suggestions when necessary. The module may also support multi-touch gestures, keyboard shortcuts, and alternative input methods, enhancing accessibility and usability across different devices and platforms.

In some embodiments, the real-time scaling module 250 is configured to process and execute dynamic resizing operations for fence components within the 3D modeling system. This module interprets user inputs, such as drag-to-scale actions, numerical dimension entries, or incremental adjustments via interface controls, and translates them into real-time modifications of the 3D model. The module ensures that scaling operations maintain proportional integrity, adhere to predefined constraints, and update seamlessly within the graphical user interface. The real-time scaling module 250 may utilize transformation matrices and vector calculations to adjust the dimensions of fence components, such as panels, posts, and gates. When a user modifies a component's size, the module recalculates the positions of adjacent elements to maintain proper spacing and alignment. For instance, if a panel is extended, the module may automatically reposition connecting posts while ensuring that the panel length remains within predefined limits, such as between one to twenty feet or other project-specific dimensions. To prevent unrealistic configurations, the module may incorporate collision detection algorithms that analyze object boundaries and restrict overlapping or misaligned placements. It may enforce minimum and maximum scaling limits by referencing stored metadata associated with each fence component. These constraints may be defined in a configuration file or database, allowing for flexible parameter adjustments based on different fence styles and materials. The module may operate in conjunction with the interaction handler module 260 to process user input events and trigger appropriate scaling functions. It may also communicate with the rendering engine 230 to ensure that visual updates occur in real time. The rendering engine may use GPU-accelerated techniques, such as shader programs, to interpolate scaling changes smoothly and maintain graphical performance across different computing environments. In some embodiments, the real-time scaling module 250 may support non-uniform scaling, allowing users to independently adjust width, height, and depth dimensions of components. Additionally, it may enable snap-to-grid functionality, which rounds user adjustments to predefined increments, improving precision in fence design. By integrating with external configuration APIs, the module may retrieve manufacturer-specific constraints, such as standard panel sizes or gate width requirements, ensuring that scaled components remain compatible with real-world production and installation standards.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

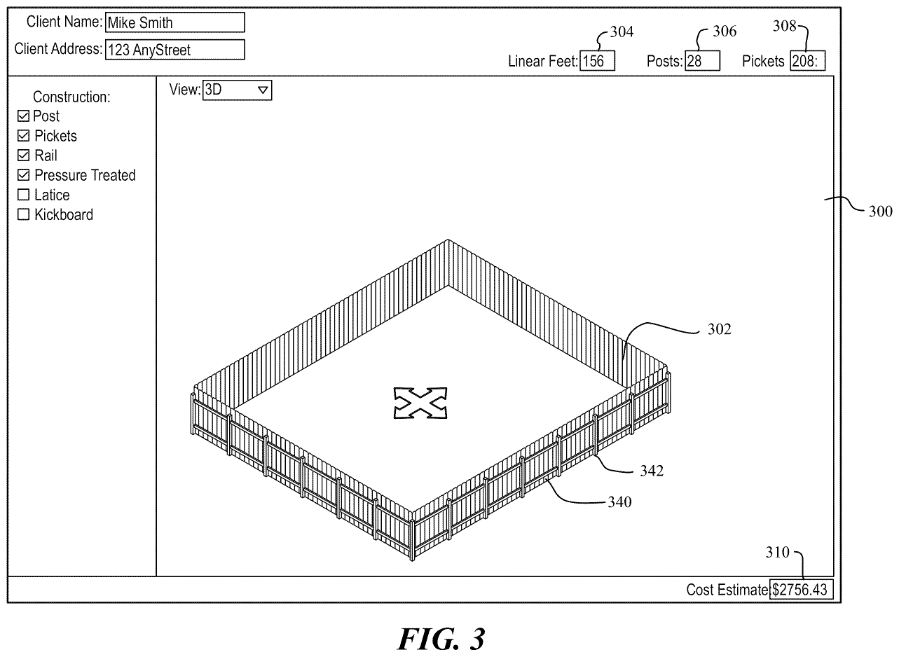

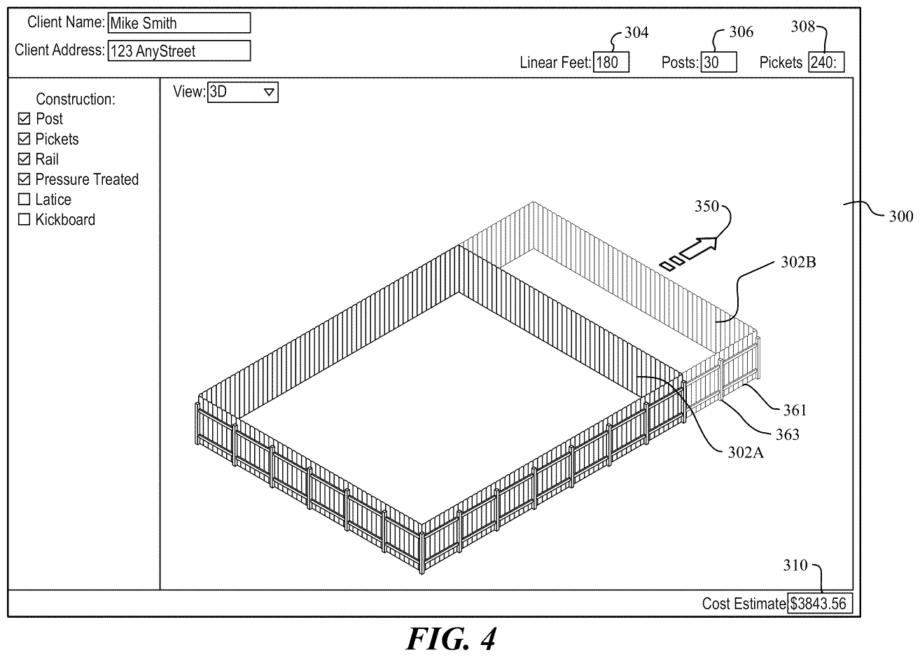

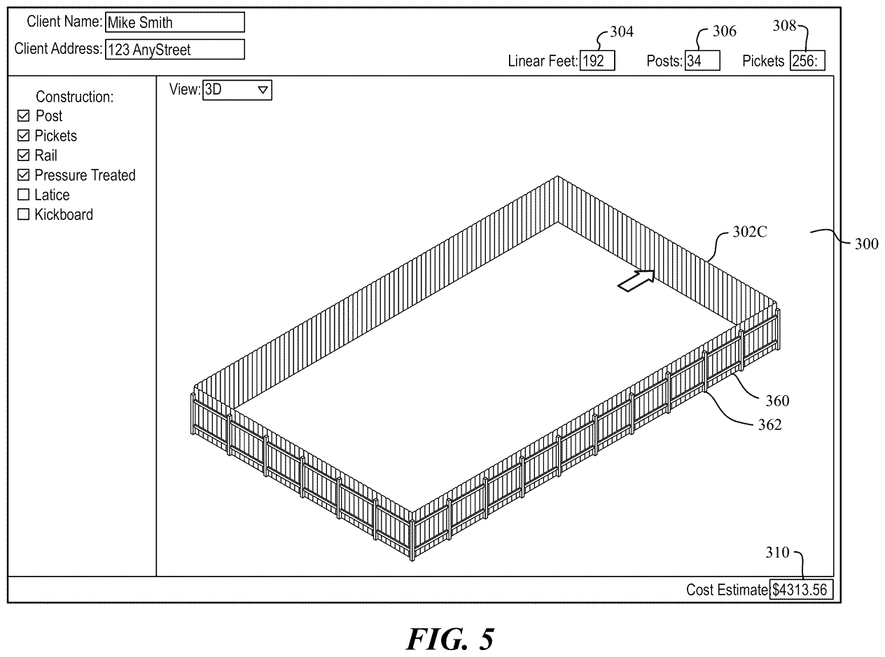

FIGS. 3-5 illustrate example user interfaces of a real-time three-dimensional fence model adaptation and visualization tool including a three-dimensional user interface (UI) 300 including a rendered fence 302 model including one or more panels 340 and posts 342 making up the fence 302. The UI 300 may include fence construction features including client details, project information, fence construction tools and features, including fence features. The UI 300 may be configured to display the dynamically rendered fence 300 and linear feet 304, post 306 count, picket 308 (panel) count, and cost estimates 310 calculated based on the linear feet 304, post 306 count, picket 308 count, and which may all be dynamically calculated as the fence 302 is dynamically adjusted by a user via the UI 300. Referring to FIG. 4, a user may interact with the UI 300 such as via a keyboard and mouse, touch screen, or other input, to “drag” 350 the rendered fence 302 from a first render 302A to an in-motion render 302B to achieve desired dimensions. During the drag 350, the system is configured to dynamically render the number of panels 340 and posts 342 to a dynamic panel 361 and dynamic post 363 render, depending on the movement of drag 350. Similarly, the system dynamically calculates linear feet 304, post 306 count, picket 308 (panel) count as the fence 302 is adjusted by a user via the UI 300 in real-time. Referring to FIG. 5, upon completing a drag, the system renders a finished fence 302C with one or more panels 360 and posts 362 and real-time recalculated linear feet 304, post 306 count, picket 308 (panel) count.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented method for real-time three-dimensional model adaptation and visualization, the method comprising:
rendering, via a computing device, a fence in a three-dimensional computer model; and
dynamically scaling, via the computing device, the fence in real-time based on user input to the three-dimensional computer model.

2. The computer-implemented method of claim 1, wherein the fence comprises at least one of a post, a gate, or a panel.

3. The computer-implemented method of claim 1, further comprising inserting at least one of a post, a gate, or a panel.

4. The computer-implemented method of claim 3, wherein the dynamically scaling comprises dimensionally changing a portion of the fence based on the inserting at least one of a post, a gate, or a panel.

5. The computer-implemented method of claim 1, wherein the at least one panel is dynamically scalable between approximately one and fifteen feet in length.

6. The computer-implemented method of claim 1, wherein the user input comprises drag-to-scale input.

7. The computer-implemented method of claim 1, wherein the user input comprises drag-and-drop input of at least one of a post, a gate, or a panel.

8. The computer-implemented method of claim 7, further comprising dynamically adjusting the fence in real-time to include the at least one post, gate, or panel.

9. A system comprising:
at least one computing device in operable communication with a network;
an application server in operable communication with the at least one computing device over the network, the application server configured to host an application program configured to:
render a fence in a three-dimensional computer model; and
dynamically scale the fence in real-time based on user input to the three-dimensional computer model.

10. The system of claim 9, wherein the fence comprises at least one of a post, a gate, or a panel.

11. The system of claim 9, wherein the application program is further configured to: insert at least one of a post, a gate, or a panel.

12. The system of claim 11, wherein the dynamically scaling comprises dimensionally changing a portion of the fence based on the inserting at least one of a post, a gate, or a panel.

13. The system of claim 9, wherein the at least one panel is dynamically scalable between approximately one and fifteen feet in length.

14. The system of claim 9, wherein the user input comprises drag-to-scale input.

15. The system of claim 9, wherein the user input comprises drag-and-drop input of at least one of a post, a gate, or a panel.

16. The system of claim 15, wherein the application program is further configured to: dynamically adjust the fence in real-time to include the at least one post, gate, or panel.

17. A software product comprising at least one computer readable storage media having application instructions collectively stored on the at least one computer readable storage media, the application instructions executable to:
render a fence in a three-dimensional computer model; and
dynamically scale the fence in real-time based on user input to the three-dimensional computer model comprising changing a portion of the fence based on the inserting at least one of a post, a gate, or a panel into the three-dimensional computer model.

18. The system of claim 9, wherein the user input comprises drag-and-drop input of at least one of a post, a gate, or a panel.
